(19) United States
(12) Patent Application Publication
(10) Pub. No.: US 2006/0135132 A1
(43) Pub. Date: Jun. 22, 2006

(54) Storing anti-spam black lists

(75) Inventors: Yigang Cai, Naperville, IL (US); Shehryar S. Qutub, Hoffman Estates, IL (US); Alok Sharma, Lisle, IL (US)

Correspondence Address: WERNER ULRICH, 434 MAPLE STREET, GLEN ELLYN, IL, 60137-3826, US

(73) Assignee: Lucent Technologies, Inc.

(21) Appl. No.: 11/018,899

(22) Filed: Dec. 21, 2004

(51) Int. Cl. H04Q 7/20

(52) U.S. Cl. 455/414.1; 455/403

(57) ABSTRACT

A method and apparatus for blocking unwanted messages (spam) in a telecommunications network. A location server of the network stores black lists of message sources which are known or believed to be generators of spam messages, or sources from which a particular destination does not wish to receive messages. When a location inquiry is made to a location server, such as a home location register (HLR) of a mobile network or a home subscriber server (HSS) of an Internet Protocol network, wherein is stored a table of sources which have been black listed because they are believed to be sources of spam messages. Advantageously, this arrangement avoids use of network resources to make extensive checks to identify spam messages.

### RELATED APPLICATION(S)

This application is related to the applications of:

Yigang Cai, Shehryar S. Qutub, and Alok Sharma entitled “Anti-Spam Server”;

Yigang Cai, Shehryar S. Qutub, and Alok Sharma entitled “Detection Of Unwanted Messages (Spam)”;

Yigang Cai, Shehryar S. Qutub, and Alok Sharma entitled “Unwanted Message (Spam) Detection Based On Message Content”;

Yigang Cai, Shehryar S. Qutub, Gyan Shanker, and Alok Sharma entitled “Spam Checking For Internetwork Messages”;

Yigang Cai, Shehryar S. Qutub, and Alok Sharma entitled “Spam White List”; and

Yigang Cai, Shehryar S. Qutub, and Alok Sharma entitled “Anti-Spam Service”;

which applications are assigned to the assignee of the present application and are being filed on an even date herewith.

### TECHNICAL FIELD

This invention relates to the storing of black lists for use in detecting and blocking unwanted (spam) messages.

### BACKGROUND OF THE INVENTION

With the advent of the Internet, it has become easy to send messages to a large number of destinations at little or no cost to the sender. The messages include the short messages of short message service. These messages include unsolicited and unwanted messages (spam) which are a nuisance to the receiver of the message who has to clear the message and determine whether it is of any importance. Further, they are a nuisance to the carrier of the telecommunications network used for transmitting the message, not only because they present a customer relations problem with respect to irate customers who are flooded with span, but also because these messages, for which there is usually little or no revenue, use network resources. An illustration of the seriousness of this problem is given by the following two statistics. In China in 2003, two trillion short message service (SMS) messages were sent over the Chinese telecommunications network; of these messages, an estimated three quarters were spam messages. The second statistics is that in the United States an estimated 85-90% of e-mail messages are spam.

A number of arrangements have been proposed and many implemented for cutting down on the number of delivered spam messages. Various arrangements have been proposed for analyzing messages prior to delivering them. According to one arrangement, if the calling party is not one of a pre-selected group specified by the called party, the message is blocked. Spam messages can also be intercepted by permitting a called party to specify that no messages destined for more than N destinations are to be delivered.

A called party can refuse to publicize his/her telephone number or e-mail address. In addition to the obvious disadvantages of not allowing callers to look up the telephone number or e-mail address of the called party, such arrangements are likely to be ineffective. An unlisted e-mail address can be detected by a sophisticated hacker from the IP network, for example, by monitoring message headers at a router. An unlisted called number simply invites the caller to send messages to all 10,000 telephone numbers of an office code; as mentioned above, this is very easy with present arrangements for sending messages to a plurality of destinations.

Most spam messages are detected through the use of black lists, i.e., lists of sources from which individual destination terminals are unwilling to accept messages. Determination of whether a message is a spam message is a difficult problem which frequently requires a very large amount of data processing. Therefore, it would be desirable to have an arrangement in which, if a source is on a black list, that the message can be quickly identified as being a spam message.

### SUMMARY OF THE INVENTION

An advance is made over the teachings of the prior art in accordance with this invention wherein black lists are stored in the servers such as the home location register (HLR) of mobile networks or the home subscriber server (HSS) of the Internet. These servers are used to identify the telecommunications terminal associated with a caller-provided address such as a telephone number or an Internet identifier, or, in the case of short message service, a mobile directory number. Since it is a necessary step as part of the process of setting up a message connection to identify the location of a called party, thus requiring an access to a location server such as the HLR or HSS, it is advantageous to use that opportunity to find out if the caller's identity is on a black list stored along with other data for the called party.

When a network node (such as a gateway mobile switching center, an internetwork mobile switching center, an SMS center, a Multimedia Message Service (MMS) center, an e-mail server, or an IP router) receives an SMS message from any network (SS7 or IP), it needs to check the location server for validating the sender and find out a routing address for an SMS receiver. The inquiry message will contain sender and/or receiver address information. The location server then screens the inquiry message using the black list to see if one or more of the sender's identities fall into the black list; if so, the location server will respond to the originating network node with an error message indicating that the source is a source of spam short messages or messages. The network node can then generate a call detail record associated with the spam SMS. A spam SMS message may be deleted upon completion of analysis or stored for record keeping. If the screening is successful and no spam indication is found, the location server will perform the normal location service and return the acknowledgment to the requesting network node.

### BRIEF DESCRIPTION OF THE DRAWING(S)

FIG. 1 is a block diagram illustrating the operation of Applicants' invention.

### DETAILED DESCRIPTION

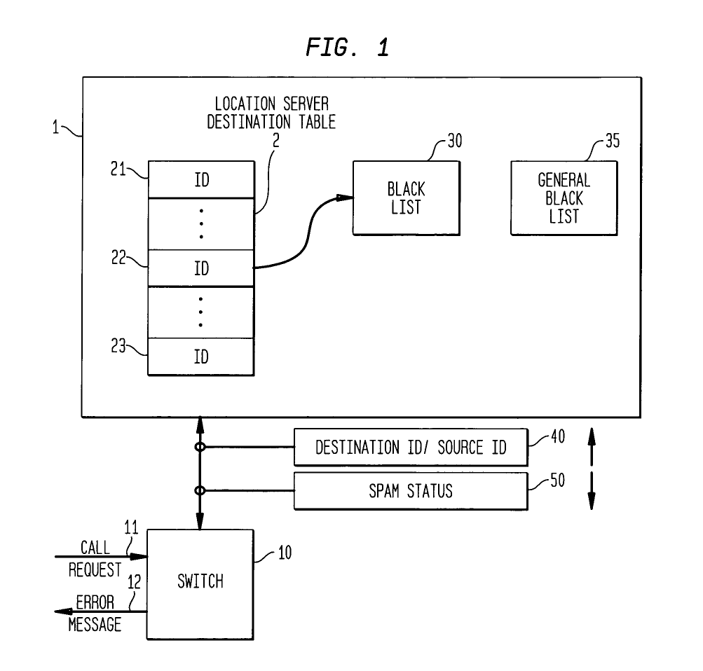

FIG. 1 is a diagram showing the operation of Applicants' invention. A switch 10 (not only mobile or landline switch, but also gateway switch, interworking switch, SMSC, MMSC, email server) receives a call request message 11. The call request message may come from a mobile switching center. At any rate, the switch 10 is the switch which makes a request to a location server 1 for information on how to complete the call including an indication of the present location of the called party. The location server can be a home location register, in the case of a mobile or short message service network, or it can be a home subscriber server in an Internet Protocol network. In addition to performing its normal functions, the location server, in accordance with the principles of Applicants' invention, contains black lists for message sources which have been identified as generating spam messages. The location server contains a list 2 of destination identities 21, . . . ,22, . . . ,23. A location server receives a request message 40 including a source and destination identity. The location server checks the destination identity table, in this case, entry 22, which includes a pointer to the black list of the destination specified in message 40. If the result of a check of black list 30, the black list pointed to by the pointer in destination identification entry 22, then the location server will generate a spam status message 50 indicating that the source is a spam source.

In accordance with one feature of Applicants' invention, the location server also stores a general black list 35 of sources which are known to be sources of spam messages and whose spam messages should be blocked. If the source specified in message 40 is on the list of such sources stored in table 35, then a spam status message 50 is generated indicating this fact.

The spam status message 50 is part of a longer message (not shown) giving the full response of the location server to the location server request 40.

If the destination identity is not found in table 2, or the source is not found in either table 30 or 35, then the spam status message 50 will indicate that from the point of view of black lists the spam status is satisfactory. Other spam tests can then be performed. Advantageously, the black list check performed in this way can save the utilization of processing resources for performing more complex spam checks in the case that a black list entry has been found.

If a black list entry has been found, the switch 10 can send an error message 12 to the source of the call request or can simply block further completion of the message connection. Further, depending on the spam status and on additional information included in a black list entry, the switch may make a record of the spam message and/or generate a report to the telecommunications carrier. Switch 10 and network management may perform further anti-spam analysis on spam source and spam messages.

While this description has been aimed primarily at short message service and Internet connections, it can also be used for regular mobile message connections, and for voice connections including voice over Internet Protocol connections and voice mobile connections. The black list entry can contain different sources, such as individual source (Mobile Directory Number (MDN), Mobile Identification Number (MIN) email address, IP address and Network or System sources (such as network ID, Domain Name, Application Server ID (and address)). The black list entry can also contain service types, message types, content types and other information as to be black listed; for example, short message service calls may be blocked but mobile voice connections allowed (or vice versa). In the case of the e-mail address, the black list contains the identity of the e-mail addressee, not only the e-mail server.

The above description is of one preferred embodiment of Applicants' invention. Other embodiments will be apparent to those of ordinary skill in the art without departing from the scope of the invention. The invention is limited only by the attached claims.

We claim:

1. In a telecommunications network a method of blocking unwanted message or voice connections comprising the steps of:
receiving a call request in a switch of said telecommunications network;
requesting the service of a location server to identify the location of a called party of said call request;
in said location server, checking whether a source of said call request is on a black list of sources for which connections are to be denied;
responsive to finding that said destination is on said black list, sending a response message to said switch to deny establishment of a connection specified in said call request.

2. The method of claim 1 wherein said black list comprises lists of sources for which connections to specific destinations are to be denied.

3. The method of claim 1 wherein said black list of sources comprises one or more lists of sources for which connections to all destinations are to be denied.

4. The method of claim 1 in which said location server is a home location register of a mobile telecommunications system.

5. The method of claim 1 wherein said location server is a home subscriber server of the Internet.

6. The method of claim 1 wherein said connection specified in said call request is a telephone connection.

7. The method of claim 1 wherein said call request is for a short message service connection.

8. The method of claim 1 wherein said call request is for a mobile telephone service connection.

9. The method of claim 1 wherein said connection is for an Internet connection.

10. In a telecommunications network, apparatus for blocking unwanted message or voice connections, said apparatus comprising:
means for receiving a call request in a switch of said telecommunications network;
means for requesting the service of a location server to identify the location of a called party of said call request;
in said location server, means for checking whether a source of said call request is on a black list of sources for which connections are to be denied;
responsive to finding that said destination is on said black list, means for sending a response message to said switch to deny establishment of a connection specified in said call request.

11. The apparatus of claim 10 wherein said black list comprises lists of sources for which connections to specific destinations are to be denied.

12. The apparatus of claim 10 wherein said black list of sources comprises one or more lists of sources for which connections to all destinations are to be denied.

13. The apparatus of claim 10 in which said location server is a home location register of a mobile telecommunications system.

14. The apparatus of claim 10 wherein said location server is a home subscriber server of the Internet.

15. The apparatus of claim 10 wherein said connection specified in said call request is a telephone connection.

16. The apparatus of claim 10 wherein said call request is for a short message service connection.

17. The apparatus of claim 10 wherein said call request is for a mobile telephone service connection.

18. The apparatus of claim 10 wherein said connection is for an Internet connection.
